(19) United States
(12) Patent Application Publication
(10) Pub. No.: US 2008/0298570 A1
(43) Pub. Date: Dec. 4, 2008

(54) Caller ID information transmitting and receiving apparatus and method thereof

(76) Inventor: Chih Chiang Wang, Jiaoxi Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,924

(22) Filed: Oct. 30, 2007

(30) Foreign Application Priority Data
May 29, 2007 (TW) 096119207

(51) Int. Cl. H04M 1/56; H04M 1/64; H04M 3/42; H04Q 7/20

(52) U.S. Cl. 379/142.01; 379/88.21; 455/415; 455/466

(57) ABSTRACT

A caller ID information transmitting and receiving apparatus and method thereof are disclosed. The apparatus comprises at least the caller ID information generating module, a communication module and a caller ID information broadcasting module. The caller ID information generating module generates a caller ID information, and the communication module transmits and receives a communication signal with a base station. When the communication apparatus is operated to make a call, the communication module transmits at least a phone number and the caller ID information to the remote communication apparatus through the base station. And when the communication apparatus performs a call alert, the caller ID information broadcasting module broadcasts the received caller ID information.

### FIELD OF THE INVENTION

The invention is related to a communication apparatus, and more particularly to a communication apparatus capable of generating and broadcasting caller ID information.

### BACKGROUND OF THE INVENTION

In recent years, the communicating apparatus, such as the line telephone and the wireless phone, is very popular and becomes an important appliance for daily life. However, the traditional line telephone having basic functions of making calls and performing call alerts is limited by the analog communicating signal so that it can only broadcast a predefined ring-tone and display the phone number. The traditional wireless phone having the basic functions of broadcasting predefined ring-tones and displaying the phone number can provide other functions such as establishing a plurality of names, phone numbers and the corresponding ring-tones in phone database in advance, and when receiving a call, the wireless phone searches the corresponding ring-tone based on the phone number and text message received from the calling end and broadcasts the searched ring-tone. And if the phone number does not exist in phone database, the wireless phone broadcasts a predefined ring-tone for notifying the user to answer the call.

The drawback of the traditional line telephone is that the function is poor, and the caller can't be recognized immediately except checking the phone number dialed in. If many people sharing a line telephone, it must take one person to answer the caller and notify who the caller is looking for. Although the user can determine the identity of the caller according to the ring-tone broadcasted by the wireless phone, it is not easy for user to remember corresponding relationship between ring-tones and callers and results in erroneous determination if caller information stored in phone database is too large.

Besides, if the user doesn't carry the wireless phone with him/her, other people can't recognize the caller by the ring-tone, and even don't know who the owner of the wireless phone is.

In order to solve the drawbacks of the traditional technology, and to satisfy the request of the user in the caller ID information of the communication apparatus, the inventor based on years of experience in the related industry to conduct extensive researches and experiments, and finally developed a caller ID information transmitting and receiving apparatus and method thereof in accordance with the present invention to overcome the aforementioned drawbacks.

### SUMMARY OF THE INVENTION

For solving the drawback mentioned above, the objective of the present invention is to provide a caller ID information communication apparatus and method thereof, and more particularly for providing a caller ID information transmitting and receiving line phone and wireless phone capable of generating and broadcasting the caller ID information. Therefore, the caller is able to be recognized easily and the owner of the communication apparatus can also be recognized easily.

To achieve the objective mentioned above, the invention provides a caller ID information transmitting and receiving apparatus comprising a caller ID information generating module, a communication module and a caller ID information broadcasting module. The caller ID information generating module is for generating the caller ID information, and the communication module is for performing transmitting and receiving of communication signal with a base station.

When the communication apparatus is operated to make a call, the communication module transmits at least a phone number and the caller ID information to a remote communication apparatus through the base station. And the caller ID information broadcasting module broadcasts the received caller ID information when the communication apparatus performs a call alert.

To achieve the objective mentioned above, the present invention further provides a caller ID information transmitting and receiving method. The method is applied for a communication apparatus and comprises the following steps of:

(a) using a caller ID information generating module to generate a caller ID information.

(b) using a communication module to transmit and receive a communication signal with a base station.

(c) using the communication module to transmit at least a phone number and the caller ID information to a remote communication apparatus through the base station when the communication apparatus is operated to make a call.

(d) using a caller ID information broadcasting module to broadcast the received caller ID information when the communication apparatus performs a call alert.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

The subject matter regarded as the invention is particularly pointed out and distinctly claimed in the concluding portion of the specification. The invention, both as to device and method of operation, together with features and advantages thereof may best be understood by reference to the following detailed description with the accompanying drawings in which:

FIG. 1 is a block diagram of the caller ID information transmitting and receiving apparatus in accordance with the present invention,

FIG. 2A is a block diagram of the first embodiment of the caller ID information transmitting and receiving apparatus in accordance with the present invention,

FIG. 2B is a block diagram of the second embodiment of the caller ID information transmitting and receiving apparatus in accordance with the present invention,

FIG. 2C is a block diagram of the third embodiment of the caller ID information transmitting and receiving apparatus in accordance with the present invention,

FIG. 2D is a block diagram of the forth embodiment of the caller ID information transmitting and receiving apparatus in accordance with the present invention, and

FIG. 3 is a flow diagram of the caller ID information transmitting and receiving method in accordance with the present invention.

### DETAILED DESCRIPTION OF THE PREFERRED EMBODIMENTS

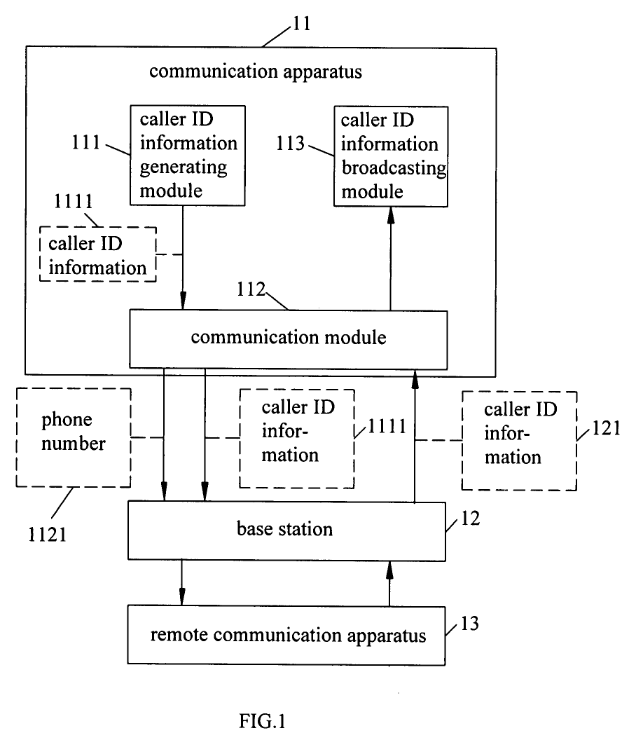

Please referring to FIG. 1 for a block diagram of the caller ID information transmitting and receiving apparatus in accordance with the present invention, communication apparatus 11, such as a line telephone or a wireless phone, comprises a caller ID information generating module 111, a communication module 112 and a caller ID information broadcasting module 113. The caller ID information generating module 111 generates a caller ID information 1111. Preferably, caller ID information 1111 can include voice message, such as a ring-tone, or text message.

The communication module 112 communicates with a base station 12 for transmitting and receiving data. When the communication apparatus 11 is operated to make a call, the communication module 112 transmits a phone number 1121 and the caller ID information 1111 to a remote communication apparatus 13 through the base station 12.

When the communication apparatus 11 performs a call alert, the caller ID information broadcasting module 113 broadcasts the caller ID information 121 received from the base station 12. Preferably, the caller ID information 121 s related to the caller ID information 1111. If the caller ID information 121 has a voice message, the caller ID information broadcasting module 113 will playback this voice message. If the caller ID information 121 has a text message, the caller ID information broadcasting module 113 will display this text message.

The communication apparatus 11 further comprises a phone database and the text message corresponding to the phone number 1121 is selected from the phone database. Preferably, the caller ID information generating module 111 can comprise a recording unit for recording voice, and the caller ID information broadcasting module 113 can comprises a speech voice synthesis unit for generating a synthetic speech corresponding to the text message received by the communication module 112.

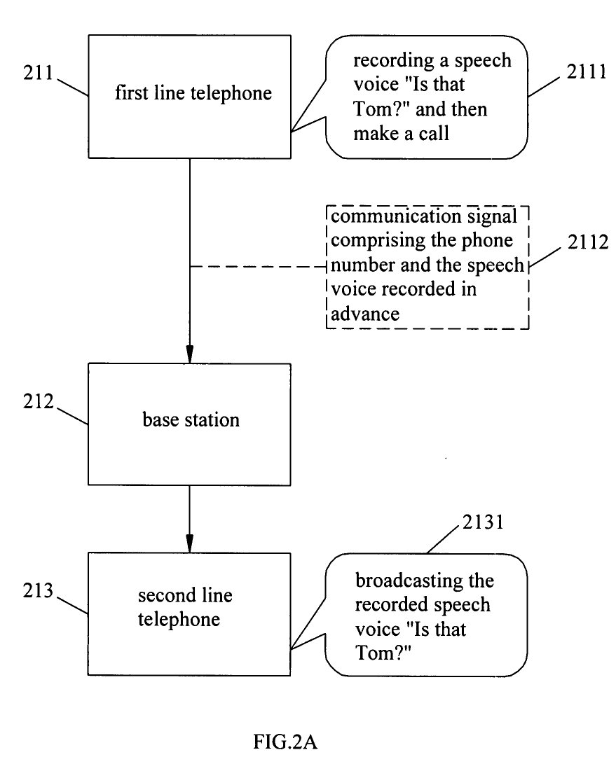

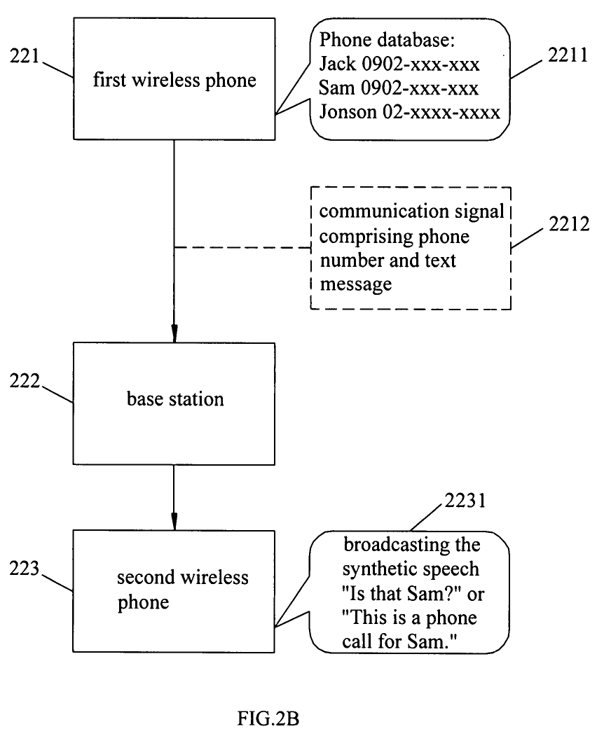

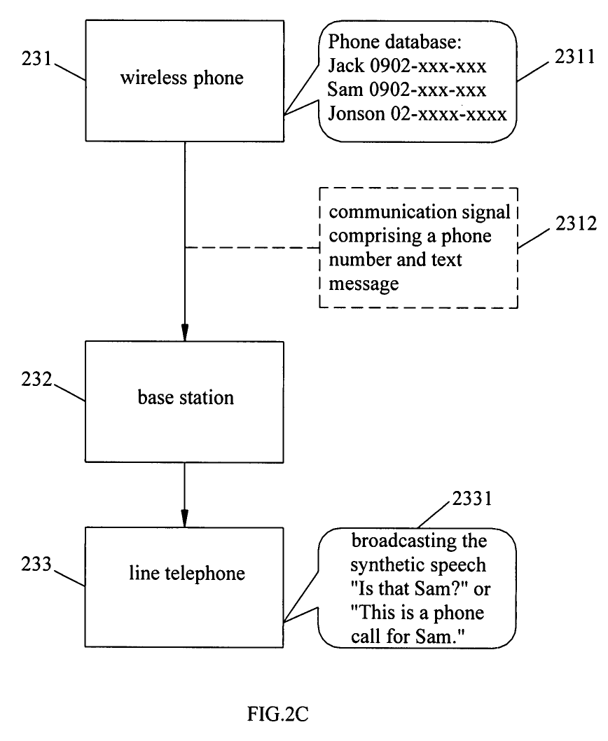

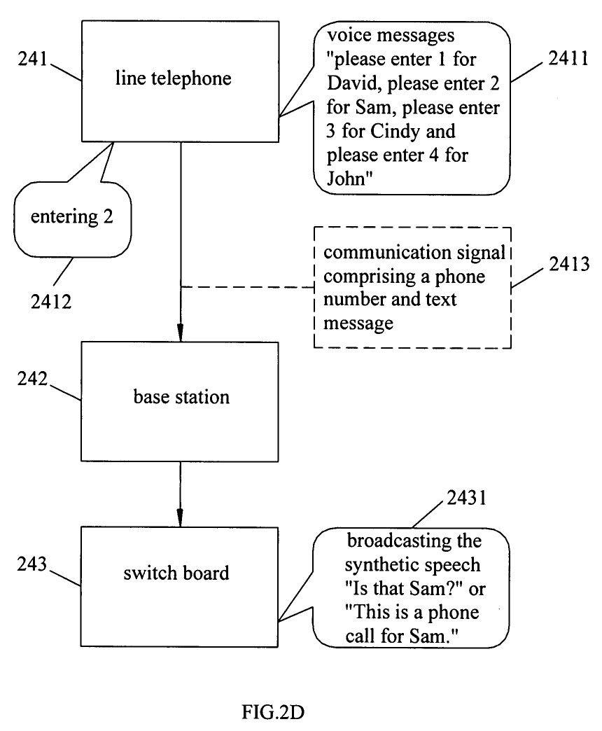

Please referring to FIG. 2A for a block diagram of the first embodiment of the caller ID information transmitting and receiving apparatus in accordance with the present invention, the communication apparatuses comprise a first line telephone 211 and a second line telephone 213, the user operates the first line telephone 211 to make a call and a call alert is performed by the second line telephone 213. At first, the caller uses the recording unit in the first line telephone 211 to record a speech voice, such as “Is that Tom?”, and then make a call.

Then, the communication module of the first line telephone 211 transmits the communication signal 2112 comprising the phone number and the speech voice recorded in advance to the remote second line telephone 213 through the base station 212. And the caller ID information broadcasting module of the second line telephone 213 broadcasts the recorded speech voice “Is that Tom?” to notice Tom for answering the call 2131.

Please referring FIG. 2B for a block diagram of the second embodiment of the caller ID information transmitting and receiving apparatus in accordance with the present invention, the communication apparatuses comprise a first wireless phone 221 and a second wireless phone 223, the user operated the first wireless phone 221 to make a call, and the call alert is performed in the second wireless phone 223. Before making a call, the caller establishes several caller ID information comprising text messages and phone numbers in the database 2211, such as: Jack 0902-xxx-xxx, Sam 0902-xxx-xxx, Jonson 02-xxxx-xxxx.

When the caller makes a call for Sam by selecting the name of Sam in database 2211 or inputting the phone number of Sam, the first wireless phone 221 transmits a communication signal 2212 comprising phone number and text message to the second wireless phone 223 through the base station 222. And the speech synthesis unit of the second wireless phone 223 generates a synthetic speech 2231 based on the text message received from the first wireless phone 221, and then the second wireless phone 223 broadcasts the synthetic speech 2231 such as “Is that Sam?” or “This is a phone call for Sam.” to notice Sam for answering the call.

Please referring to FIG. 2C for a block diagram of the third embodiment of the caller ID information transmitting and receiving apparatus in accordance with the present invention, the communication apparatus comprises a wireless phone 231 and a line telephone 233. The wireless phone 231 is applied for making a call, and the line telephone 233 is applied for performing the call alert. Before making a call by the wireless phone 231, the caller establishes several caller ID information comprising name and related phone numbers, such as John 0902-xxx-xxx, Cindy 0902-xxx-xxx and David 02-xxxx-xxxx in the database 2311. Then the user dials a phone number by selecting a name, ex. David, from the database 2311 or inputting a phone number by using the keyboard of the wireless phone 231.

The communication module of the wireless phone 231 transmits a communication signal 2312 comprising a phone number and text message to a remote line telephone 233 through the base station 232. The speech synthesis unit of the line telephone 233 generates a synthetic speech corresponding to the caller ID information received by the communication module mentioned above. And the line telephone 233 broadcasts a synthetic speech such as “Is that David?” or “This is a phone call for David.” to notice David for answering the call from the wireless phone 231.

Please referring to FIG. 2D for a block diagram of the forth embodiment of the caller ID information transmitting and receiving apparatus in accordance with the present invention, the communication apparatuses comprise a line telephone 241 and a switch board 243, and user operates the line telephone 241 to make a call and the switch board 243 is applied for performing the call alert. Before the caller makes a call by the line telephone 241, several voice messages, such as “please enter 1 for David, please enter 2 for Sam, please enter 3 for Cindy and please enter 4 for John”, must be established in the switch board 243. When the caller makes a call by the line telephone 241 to the switch board 243, the caller can receive the voice message 2411 such as “please enter 1 for David, please enter 2 for Sam, please enter 3 for Cindy and please enter 4 for John”.

Meanwhile, the caller can select the receiver 2412 by entering number, such as entering 2 for Sam, and the communication module of the line telephone 241 transmits a communication signal 2413 comprising a phone number and the text message to the remote switch board 243 through the base station 242. Finally, the speech synthesis unit of the switch board 243 generates a synthetic speech corresponding to the caller ID information received by the communication module mentioned above. And the switch board 243 broadcasts a synthetic speech 2431 such as “Is that Sam?” or “This is a phone call for Sam.” to notice Sam for answering the call from wireless phone 241.

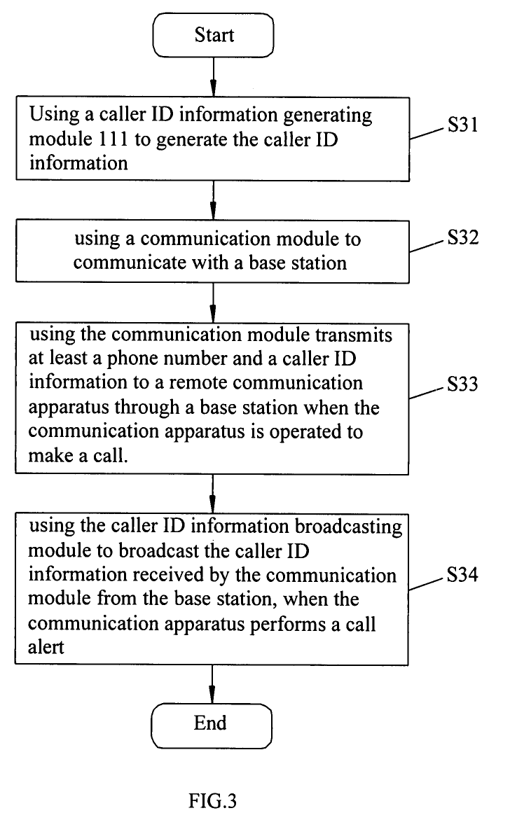

Please referring to FIG. 3 for a flow diagram of the caller ID information transmitting and receiving method in accordance with the present invention, the method shown in FIG. 3 is corresponding to the apparatus in FIG. 1 and is suitable for a communication apparatus 11 such as a line telephone or a wireless phone. The method including the steps as following:
Step S31: Using a caller ID information generating module 111 to generate the caller ID information 1111, such as a ring-tone or text message. Preferably, the caller ID information generating module 111 can comprise a recording unit for recording a voice message.
Step S32: using a communication module 112 to communicate with a base station 12.
Step S33: using the communication module 112 transmits at least a phone number 1121 and a caller ID information 1111 to a remote communication apparatus 13 through a base station 12 when the communication apparatus 11 is operated to make a call.
Step S34: using the caller ID information broadcasting module 113 to broadcast the received caller ID information 121 when the communication apparatus 11 performs a call alert. The caller ID information 121 comprises voice message or text message, preferably, the caller ID information 121 is related to the caller ID information 111 1.

Preferably, the caller ID information broadcasting module 113 comprises a speech synthesis unit which is applied for generating a synthetic speech corresponding to the text message received by the communication module 112. The communication apparatus 11 usually comprises a phone database, and the text message corresponding to the phone number 1121 is selected from the phone database.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication apparatus capable of transmitting and receiving caller ID information, at least comprising:
a caller ID information generating module, for generating a caller ID information;
a communication module, for performing transmitting and receiving of communication signal with a base station; and
a caller ID information broadcasting module;
wherein said communication module transmits at least a phone number and said caller ID information to a remote communication apparatus through said base station when said communication apparatus is operated to make a call, and said caller ID information broadcasting module broadcasts said received caller ID information when said communication apparatus performs a call alert.

2. The communication apparatus of claim 1, wherein said communication apparatus comprises a line telephone or a wireless phone.

3. The communication apparatus of claim 1, wherein said caller ID information comprises a voice message.

4. The communication apparatus of claim 3, wherein said caller ID information generating module comprises a voice recording unit for recording said voice message.

5. The communication apparatus of claim 3, wherein said voice message comprises a ring-tone.

6. The communication apparatus of claim 1, wherein said caller ID information comprises a text message.

7. The communication apparatus of claim 6, further comprising a phone database, wherein said text message is chosen from said phone database and corresponding to said phone number.

8. The communication apparatus of claim 6, wherein said caller ID information broadcasting module comprises a speech synthesis unit for generating a synthetic speech corresponding to said text message received by said communication module.

9. A method for transmitting and receiving caller ID information, applied for a communication apparatus, said method comprises the steps of:
using a caller ID information generating module to generate a caller ID information;
using a communication module to transmit and receive a communication signal with a base station;
using said communication module transmits at least a phone number and said caller ID information to a remote communication apparatus through said base station when said communication apparatus is operated to make a call; and
using a caller ID information broadcasting module to broadcast said received caller ID information when said communication apparatus receives a call.

10. The method of claim 9, wherein said communication apparatus comprises a line telephone or a wireless phone.

11. The method of claim 9, wherein said caller ID information comprises a voice message.

12. The method of claim 11, wherein said caller ID information generating module comprises a voice recording unit for recording said voice message.

13. The method of claim 11, wherein said voice message comprises a ring-tone.

14. The method of claim 9, wherein said caller ID information comprises a text message.

15. The method of claim 14, further comprising establishing a database, wherein said text message corresponding to said phone number is selected from said database.

16. The method of claim 14, wherein said caller ID information broadcasting module comprises a speech synthesis unit for generating a synthetic speech corresponding to said text message received by said communication module.
